(19) United States
(12) Patent Application Publication
(10) Pub. No.: US 2007/0260697 A1
(43) Pub. Date: Nov. 8, 2007

(54) Method and System for Wireless Transmission of Multi-Media Data from a Portable Multi-Media Device

(76) Inventor: Peter D. Shapiro, New York, NY (US)

Correspondence Address: Peter Shapiro, 225 East 57th Street, New York, NY, 10022, US

(21) Appl. No.: 11/627,370

(22) Filed: Jan. 25, 2007

Related U.S. Application Data
(60) Provisional application No. 60/762,078, filed on Jan. 25, 2006.

(51) Int. Cl. G06F 15/167

(52) U.S. Cl. 709/212

(57) ABSTRACT

A method and system for wireless transmission of multi-media data from a portable multi-media device to a compatible electronic device using two steps; step 1 involves conveniently selecting to the compatible electronic device using the portable multi-media device; step 2 involves transmitting multi-media data over the wireless network from the portable multi-media device to the compatible electronic device.

### CROSS REFERENCE TO RELATED APPLICATIONS

This application claims priority to, and the benefit of, U.S. Provisional Patent Application Ser. No. 60/762,078 filed Jan. 25, 2006 which his hereby incorporated by reference in its entirety.

### FIELD OF THE INVENTION

The present invention relates to providing convenient wireless transmission from a portable multi-media device to a compatible electronics device using a two-step process, where the consumer first targets a specific electronics device for transmission using a remote control mechanism, then, once the electronics device has properly initiated communication, transmission of the multi-media data takes place.

### BACKGROUND OF THE INVENTION

Portable multi-media devices, such as Apple Computer's iPod device, are one of the most popular types of consumer electronics. Traditionally such devices carried sound data, usually songs, and could play back such data for the consumer on the road. A recent trend in these devices is to incorporate numerous other types of multi-media, including images, computer data, computer software, and video data. Recent trends in lower cost memory and smaller, more compact circuitry, and longer lasting power cells have enabled such devices to become more universal.

In accord with this trend, Apple computer recently introduced a new line of iPods that are video enabled. That is, the consumer can watch movies on his or her iPod. Other types of portable multi-media devices are also capable of displaying video. On drawback of using a portable multi-media device to play video are the power limitations, which although they have improved, are still limited to several hours of video play before the battery needs to be recharged. But perhaps the most limiting factor to playing video is the small screen size of the device.

The limitations discussed above also limit the appeal these video capable portable multi-media devices have to consumers. Therefore, there is a need to allow consumers to have additional useful features on such devices, which would widen the appeal of these devices to a broader audience, who would otherwise only purchase a portable multi-media device for audio playback purposes.

Wireless communication technology has been rapidly advancing. The cost of enabling devices to communicate over a wireless network, such as an 802.11a-g type network, has dramatically decreased in recent years. There are even some portable multi-media devices, such as portable personal computers, that are capable of wireless communication.

Accordingly, there is a need for a portable multi-media device that can easily utilize wireless communication to transmit its multi-media data, in a convenient manner, to consumer electronics devices. Currently, many portable multi-media devices have sync features that allow them to be connected to a personal computer to sync the data in the multi-media device to the multi-media data that is on the consumer's computer. For example, Apple Computer has its iTunes program that allows consumers to purchase songs and videos from its iTunes store. Once the purchase is made, the multi-media data is downloaded onto the consumers personal computer. However, it will only be available to the consumer once the consumer syncs his or her iPod with the computer, usually by using a cable to connect the iPod to the computer. However, there is no way to directly link these portable mutli-media devices to other consumer devices, or even other personal computers in order to use the electronics devices in order to play back the content multi-media data stored on the portable multi-media device. Often it would be preferable to use a better medium to play back such multi-media data. For example, most consumers would prefer to watch a movie on a wide-screen television than on the tiny iPod screen.

One of the hurtles many of the companies that offer portable multi-media device products have to overcome is the problem of file-sharing. To attract a stable of quality entertainment companies to offer their products in a format compatible with a particular portable multi-media device, the vendors, like Apple Computer, have had to employ a variety of limitations on file sharing, which can sometimes become onerous. Therefore, there is a need for a convenient method of temporary file sharing from a portable multi-media device to a compatible electronics device (which may even be another portable multi-media device), such that the multi-media file can be played on the compatible electronics device in real-time without it being permanently stored on the compatible electronics device.

Heretofore, there is a need to provide a convenient method and system for wireless transmitting the multi-media data on a portable multi-media device to a compatible consumer electronics device. Also, there is a need for a system that can accommodate real-time, or streaming transmission, in order to limit the proliferation of unauthorized file sharing, and preserve the entertainment industry's ability to derive revenue from its songs, video, images and movies.

### SUMMARY OF THE INVENTION

The need in the art is addressed by the present invention which provides a system and method to allow for wireless transmission of multi-media data such as video, audio, or image, to a compatible electronic device such as a computer, audio system, or video monitor or television. The invention employs a two-step process where step one involves the initiation of communication between the portable multi-media device and compatible electronics device, and step two involves the wireless communication of the multi-media data from the portable multi-media device to the compatible electronic device.

### BRIEF DESCRIPTION OF THE DRAWINGS

The features and advantages of the present invention will become more apparent from the detailed description set forth below when taken in conjunction with the drawings.

FIG. 1 is a block diagram of an exemplary system embodying the present invention.

FIG. 2 is a flow diagram describing the steps of the present invention.

FIG. 3 is a diagram illustrating example user interfaces on the portable multi-media device for initiating the wireless communication to a compatible electronics device.

### DETAILED DESCRIPTION

The present invention is directed to a system and method for convenient wireless transmission of multi-media data from a portable multi-media device to a compatible electronics device using a two step process. The first step initiates the communication by allowing the consumer to select the compatible electronics device. For convenience sake, for the purpose of this application, this first step of initiating the communication by selecting the compatible electronics device is defined herein as the remote control mechanism. It should be noted that the remote control mechanism may indeed employ a traditional infrared type remote control apparatus but can also be used without a direct line of site remote control apparatus by, for example, detecting the what devices are available on a wireless network that are compatible with the multi-media data that was selected by the consumer. The second step involves communicating between the portable multi-media device and the compatible electronic device over the wireless network.

The present invention provides a solution to the needs described above by allowing consumers to easily transmit their multi-media files stored on their portable multi-media devices such as their iPods, to a compatible electronics devices, such as a television. So, for example, an iPod and television enabled in accordance with this invention would allow the consumer to reach into his or her pocket, take out a video iPod and point it at the enable television, press the transmit button (which is added as part of this invention, although can also be accomplished through a menu on the user interface or a softkey), and the television will start playing the video file on its display in real-time. The iPod can then be used like a remote control, where user can pause, forward, reverse, even frame advance, using the iPod controls.

In one embodiment, the wireless transmission could proceed simultaneously for different compatible electronic devices, limited only by the processing power of the portable multi-media device and the available bandwidth of the wireless network. In this fashion, in the example above, the iPod could be used to select multiple different multi-media files then use the “remote control” feature to start those files simultaneously running on different compatible electronic devices in apparent real-time. So, for example, a user could use select a slide show of image files, then use the “remote” feature to start a picture show on an Apple desktop computer by pointing at the computer and pressing the remote button. As the slide show starts running, the user could then select an audio file on the iPod then point it at a compatible audio system and press the remote control button which will start the audio file playing on the compatible audio system in accordance with this invention. Then, while both the slide show and the song are playing, the user could go on to select a video file and point it at a compatible video monitor and press the remote control button, starting the video playing on the receiver in accordance with this invention.

The remote control activation could be accomplished in a number of ways, such as through a standard remote control device using an infra red transmission signal, or through some other means, such as on a Bluetooth network, or even through the wireless network itself. An important aspect of the remote control feature is that by the user pointing it at a compatible electronic device, an initiation will occur between the portable multi-media device and the compatible electronic device that was pointed to (or uniquely identified by some other means aside from pointing), and not some other compatible electronic device that may also be in the vicinity. However, if the invention is used with only one compatible electronic device then this aspect of the remote control feature could be omitted and the remote control could be activated in any fashion, even over the wireless network, without the need to identify either device, since there are only two devices that need to communicate with each other. The remote control activation alerts the receiving device that it should initiate communication with the portable multi-media device over the wireless network connection, then start receiving the multi-media data from the portable multi-media device over the wireless network. The network can be any wireless network such as an 802.11(b) or (g) protocol based network or Bluetooth). The portable multi-media device will have software that waits for the initiation of communication from the receiving device (which could be only for a set period of time) once the remote control feature is used. Once the initial communication takes place, the software on the portable multi-media device will start transmitting the pre-selected multi-media data. In the example above, once the data stream begins to arrive on the computer, the appropriate player software could be launched based on the type of multimedia data being received over the wireless network. So, for example, in the case of an enhanced apple iPod transmitting video data in this fashion, the video data might be in Quicktime or in a JPEG based format, and the player software might be the Quicktime viewer. So in this example, the Quicktime player would then be launched to play the video as it streamed in over the wireless network, giving the enhanced iPod the feel of a regular television remote control that activates the movie in real-time.

The portable multi-media device is not limited to iPods and could be any portable device capable of storing multi-media files and wireless communication. So it might a portable (pocket PC), a laptop, a digital camera, a camcorder, a palm pilot, or even a multi-media enabled cell-phone.

The wireless transmission of the multi-media data alternatively could be initiated from the portable multi-media device instead of from the compatible electronic device. For example, the portable multi-media device would still be used to initiate the contact with the remote control feature but instead of the portable multi-media device waiting for the compatible electronic device to then initiate the communication over the wireless network, the roles could be reversed at this point, with the portable multi-media device initiating such communication while the compatible electronic device waits for the initiation to occur after receiving the remote control signal.

One embodiment of the invention has a direct line of sight infrared signal, similar to a television remote control, used by the remote control mechanism in the portable multi-media device. The compatible electronic device would have a receiving mechanism, which could be the standard infrared signal detector built in to many consumer electronic devices that already have remote control. For the invention here, the particular signal sent by the portable multi-media device would activate special software residing in the compatible electronic device to initiate contact with the portable multi-media device over the wireless network. Once that contact is initiated, the portable multi-media device will start transmitting the selected multimedia file over the wireless network. In one embodiment of the invention, the compatible electronic device will detect the type of multi-media file being received and automatically launch the appropriate player software to start playing the multi-media file (i.e. a movie on the video monitor) as the data streams in over the wireless network. The special software on the compatible electronic device may optionally also continue to monitor the data coming in over the wireless network for control data in addition to the streaming multi-media data. In this fashion the portable multi-media device can be used to control the software playing the multi-media file (for pause, fast forward, rewind, and any other relevant functions).

Other more complex remote control mechanisms may also be used within the scope of the invention. For example, the portable multi-media device might be preconfigured with the available compatible electronic devices that are on a particular wireless network through an initialization procedure. In this manner, the user of the portable multi-media device might then specify on the device's interface which compatible electronic device should play the multi-media file selected, and the remote control portion of the invention could then be accomplished through the wireless network by specifically targeting a known device for initiating the wireless transmission of the multi-media file. Alternatively, each type of multi-media file might be associated with a particular compatible electronic device in an initialization procedure (or even as part of an out of the box pre-selected system). In that case the user would only have to select the multi-media file desired then press the remote control button and the transmission will then be automatically targeted at the predefined compatible electronic device.

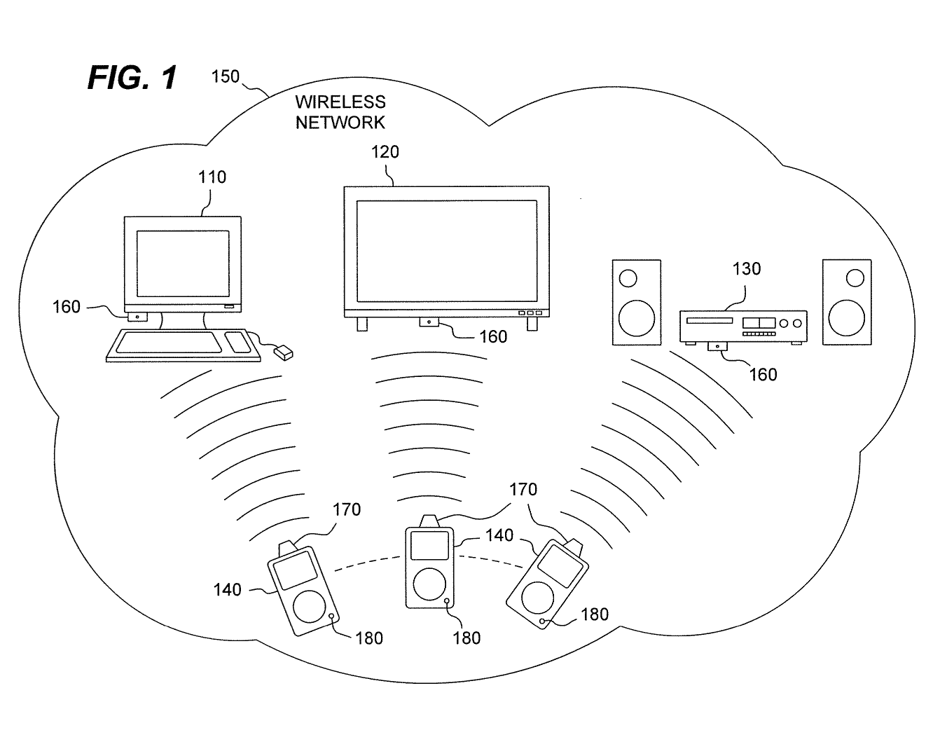

FIG. 1 is a block diagram of an exemplary system embodying the present invention. In this example, the system comprises a compatible computer, 110, a compatible video monitor, 120, and a compatible audio system, 130. The portable multi-media device, 140, is using an infrared line of sight remote control transmission mechanism, 170, to initiate communication with any of the compatible electronic devices. The user will point the portable multi-media device, 140, at said compatible electronic devices, 110, 120, and 130, and press the remote control button, 180, on the portable multi-media device, 140. This will cause an infrared signal to be transmitted from the portable multi-media device, 140, using the remote control transmission mechanism, 170, which will be received by the remote control signal receiver, 160, on the compatible electronic devices that was pointed to. Once the remote control signal has been transmitted, the portable multi-media device, 140, will wait for an initiation of communication over the wireless network, 150, from the compatible electronic device selected. Once this occurs, the portable multi-media device, 140 will start transmitting the selected multi-media data over the wireless network, 150. In an embodiment of the invention, the compatible electronic device will then detect the type of multi-media file it is receiving, either by examining the data being received, or by having received that information from a transmission by the portable multi-media device, 140, over the wireless network prior to it sending the data for the multi-media file. Once the type of multi-media file that is being transmitted is determined, the compatible electronic device can optionally launch the player software so it can play the multi-media data as it is received over the wireless network, 150, in a streaming fashion.

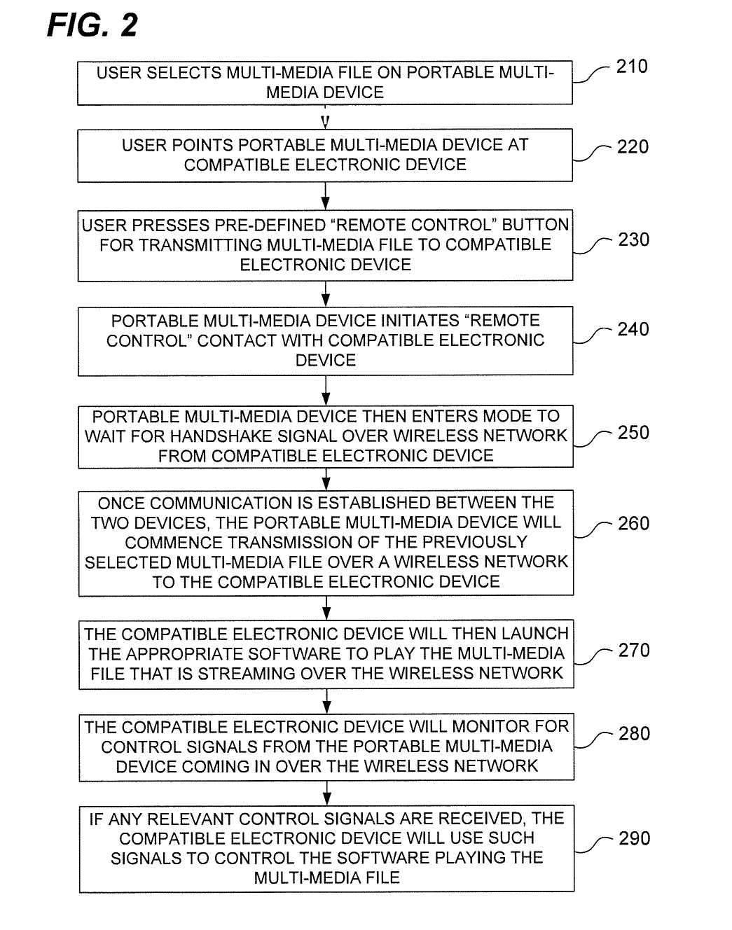

FIG. 2 is a flowchart illustrating a process according to one embodiment of the invention.

In one possible embodiment, the remote control infrared signal transmitted by the portable multi-media device and received by the compatible electronic device might itself optionally contain initialization data to enable easier communication between these devices over the wireless network. So, for example, the address information for the portable multi-media device might be contained in the infrared transmission signal sent by that device through the remote control mechanism. Then the compatible electronic device can use that address information to find the portable multi-media device on the wireless network and establish communications with it. In another simpler example, the portable multi-media device might just transmit some type of unique identifier in the infrared signal. Then when the compatible electronic device attempts to initiate contact with the portable multi-media device it can check the unique identifier to make sure it has contacted the correct device.

Alternatively, once the remote control signal is received by the compatible electronic device, it can just look for any portable multi-media device that is available over the wireless network and initiate contact with that device. If the portable multi-media device contacted is the device is waiting to transmit multi-media data, then contact will successfully be established and transmission will begin. If the portable multi-media device contacted is not waiting to transmit multi-media data then the compatible electronic device can cease contact with that device and continue to search for other portable multi-media devices that are waiting to transmit multi-media data over the wireless network. In this fashion multiple portable multi-media devices can be used with the same compatible electronic devices over the same wireless network.

In another embodiment of the present invention two-way remote control transceivers are used instead of a transmitter and receiver. In this fashion two-way communication can be established between the portable multi-media device and the compatible electronic device even before communication is established over the wireless network in order to ensure greater reliability in establishing the proper communication between the proper devices over the wireless network.

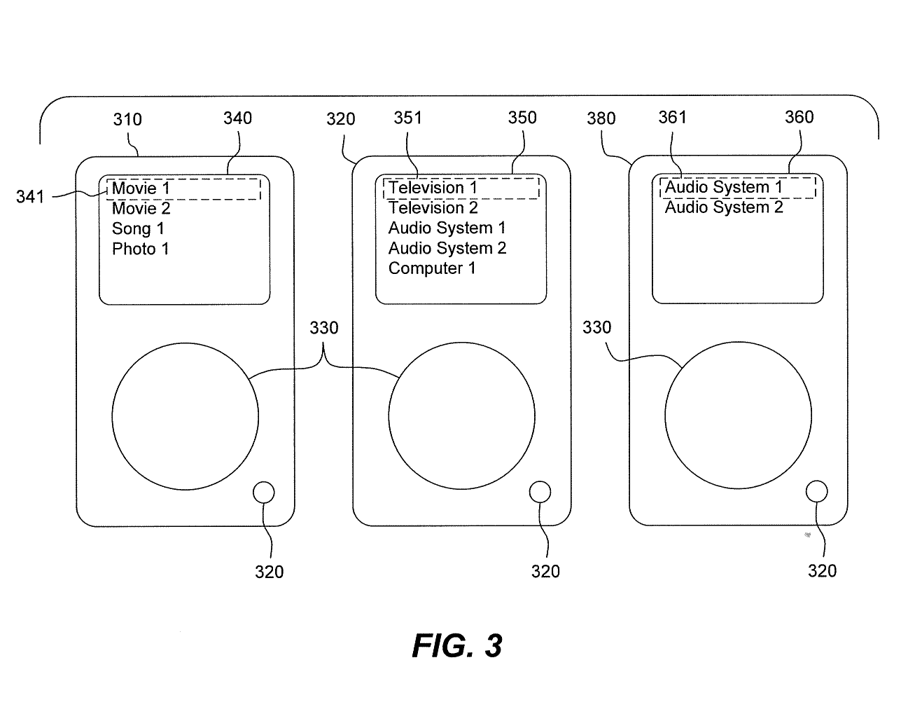

FIG. 3 depicts a portable multi-media device in accordance with one embodiment of this invention where the remote control mechanism uses a selection process on the user interface to determine compatible electronics device to transmit the multi-media data to. In this embodiment the consumer first selects the multi-media file 341 which is depicted as movie1 on a portable multi-media device in the state of 310. The selection can be made with a softkey (not shown) or with a remote control button 320. The portable multi-media device then searches for all compatible electronic devices on the wireless network and lists them on the interface screen 350, shown on the portable multi-media device in state 370. Alternatively the interface screen might only show compatible electronic devices that are capable of playing the type of multi-media device selected, so in this instances it might be limited to television1 or television2 (they might have more descriptive names like “living room TV” and “bedroom TV”). The consumer will then select a compatible electronic device using the control 330, and again press the remote control button 320 (or a softkey). This will initiate communication between the portable multi-media device and the compatible electronics device causing the multi-media file movie1 to be transmitted to compatible electronic device television1. The transmission may be in real time, or streaming, so that it will start playing on television1 right away.

If the consumer instead selects song1 on the interface screen 340 and presses remote control button 320, then if the embodiment of this invention is such that it only shows compatible electronic devices suitable for playing audio files, it might only show interface screen 360 which displays the compatible electronic devices audiosystem1 361 and audiosystem2. If the user selects device audiosystem1 and presses the remote control button 320 the portable multi-media device will start transmitting the file song1 wirelessly to audiosystem1, which might play that song in real time over the consumers sound system.

What is claimed is:

1. A system for wireless transmission of multi-media information from a portable multi-media device comprising:
one or more portable multi-media devices operable to select and transmit multi-media files over a wireless network using a remote control mechanism;
said remote control mechanism operable to allow for the selection of a compatible electronic device;
a wireless network operable to allow for the transmission of the mutli-media file from the portable multi-media device to the compatible electronic device; and
a compatible electronic device operable to communicate with the portable multi-media device in order to receive transmission of a multi-media data.

2. The system of claim 1 further comprising player software whereby the compatible electronic devices receiving the multi-media data over the wireless network will launch the player software to play the multi-media data once it is received.

3. The system of claim 2 whereby the appropriate player software is determined by analyzing the type of multi-media data being received from the portable multi-media devices over the wireless network.

4. The system of claim 2 whereby the appropriate player software is determined by a control signal transmitted from the portable multi-media devices over the wireless network.

5. The system of claim 1 further comprising software on the portable multi-media device capable of simultaneously sending out multiple streams of multi-media data to multiple compatible electronic devices.

6. The system of claim 1 further comprising special software on the compatible electronic devices which will determine if the portable multi-media device found on the wireless network is ready to transmit multi-media data, and if it is not ready, the special software will continue to look for additional portable multi-media devices on the wireless network until one such device is ready to transmit multi-media data.
A portable multi-media device operable to transmit multi-media data and/or control data to a compatible electronic device, comprising:
storage for holding multi-media data;

7. A portable multi-media device operable to transmit multi-media data and/or control data to a compatible electronic device, comprising:
storage for holding multi-media data;
a user interface operable to select multi-media data for transmission to a compatible electronics device;
a remote control mechanism operable to initiate communication with a compatible electronic device; and
a wireless communication interface operable to transmit multi-media data and/or control data over a wireless network to a compatible multi-media device.

8. The portable multi-media device of claim 7 further comprising the capability to simultaneously transmit multiple streams of multi-media data to multiple compatible electronic devices.

9. A system which incorporates the portable multi-media device according to claim 7 further comprising:
a compatible electronics device operable to receive multi-media and/or control data transmitted by the portable electronics device;
a wireless network operable to allow transmission of multi-media data and/or control data from the portable multi-media device to the compatible electronics device.

10. The system according claim 9 further comprising:
player software on the compatible electronics device operable to display the multi-media data.

11. The system according to claim 10 where said player software is selected and run to display the multi-media data based on the type of multi-media data being transmitted from the portable multi-media device.

12. The system according to claim 10 where said player software is selected and run to display the multi-media data based on control data received from the portable multi-media player.

13. The system according to claim 10 where said control data is used by the player software to pause, fast forward, stop, or rewind the display of the multi-media data.
